(19) United States
(12) Patent Application Publication
(10) Pub. No.: US 2025/0178436 A1
(43) Pub. Date: Jun. 5, 2025

(54) VEHICLE-BASED DYNAMIC AUGMENTED REALITY GAME AND ENTERTAINMENT SYSTEM

(71) Applicant: Xin Feng, Canton, MI (US)

(72) Inventor: Xin Feng, Canton, MI (US)

(21) Appl. No.: 18/526,415

(22) Filed: Dec. 1, 2023

(51) Int. Cl. B60K 35/23; G06T 19/00

(52) U.S. Cl. CPC B60K 35/23; G06T 19/006; A63F 2300/69

(57) ABSTRACT

In at least some implementations, a method includes transmitting, from a vehicle to an Augmented Reality (AR) source, vehicle data relating to a location of the vehicle, receiving at the vehicle from the AR source an AR element selected based on the vehicle data, and displaying the AR element on a display of the vehicle. The AR element is displayed in context with an area outside the vehicle, and the AR element is displayed on or near a window through which the area can be viewed or on a display on which is provided image data from a camera of the vehicle that has a field of view including the area.

### FIELD

The present disclosure relates to a vehicle and an Augmented Reality entertainment system for the vehicle.

### BACKGROUND

Vehicle simulators can provide a somewhat immersive gaming experience for vehicles that involve driving cars, but the simulators are stationary relative to the room in which they are located. Some vehicles enable users to play games on a display within the vehicle when the vehicle is not moving. The games do not relate to use of the vehicle and the vehicle dynamic movement is not part of the experience.

### SUMMARY

In at least some implementations, a method includes transmitting, from a vehicle to an Augmented Reality (AR) source, vehicle data relating to a location of the vehicle, receiving at the vehicle from the AR source an AR element selected based on the vehicle data, and displaying the AR element on a display of the vehicle. The AR element is displayed in context with an area outside the vehicle, and the AR element is displayed on or near a window through which the area can be viewed or on a display on which is provided image data from a camera of the vehicle that has a field of view including the area.

In at least some implementations, the display is a heads-up display that includes at least a portion of a windshield of the vehicle. In at least some implementations, the display is provided by a user worn device, like AR glasses.

In at least some implementations, the AR element includes one or more icons that are provided on the display so that they appear in a predetermined context relative to the area outside the vehicle.

In at least some implementations, the display of the AR element is responsive to one or more of movement of a steering wheel, movement of a throttle or movement of a brake pedal. In at least some implementations, the method also includes moving the AR element in response to actuation of an input within the vehicle.

In at least some implementations, the AR element is displayed as a function of the current location of the vehicle, with a different AR element displayed when the vehicle is at a different location.

In at least some implementations, the AR element is associated with a particular location outside the vehicle and the size of the AR element increases as the vehicle moves closer to the particular location.

In at least some implementations, the method also includes determining one or more vehicle parameters, comparing each of the one or more vehicle parameters to a corresponding threshold, and terminating the display of the AR element when one of the vehicle parameters is outside of the corresponding threshold for that vehicle parameter. In at least some implementations, one of the one or more vehicle parameters includes a vehicle speed and the corresponding threshold is a maximum vehicle speed, or the one of the one or more vehicle parameters includes a proximity of the vehicle to an obstacle and the corresponding threshold is a minimum distance of the vehicle to the object, or the one of the one or more vehicle parameters is a geofence and the corresponding threshold is a location of the vehicle relative to the geofence.

In at least some implementations, the method also includes comparing the location of the vehicle to a geofence and terminating the display of the AR element when the vehicle is outside of the geofence.

In at least some implementations, the vehicle data includes information from a GPS device. In at least some implementations, the vehicle data includes information from the camera, and the AR element is displayed as a function of image data from the camera. The vehicle data may also include data from various sensors, including proximity or object recognition sensors (e.g. radar, lidar, ultrasonic), and the AR element may be displayed as a function of the data from these sensors, and in at least some implementations, the AR element may be displayed as a function of information from both one or more cameras and one or more such sensors.

In at least some implementations, the AR element relates to a different vehicle that is connected to the AR source.

In at least some implementations, the method also includes controlling at least one of steering, throttle or braking of the vehicle as a function of information from a safety system of the vehicle. In at least some implementations, the safety system includes sensors used by an Advanced Driver Assist System, and the sensors include one or more of a camera, Lidar, Radar, and a location sensor.

In at least some implementations, the method also includes providing sound in the vehicle as a function of the AR element or the vehicle location.

In at least some implementations, a system includes a display within a vehicle, one or more communication devices of the vehicle permitting wireless communication to and from the vehicle, a vehicle control system coupled to the display and to the one or more communication devices, the vehicle control system including a controller and memory including instructions executable by the processor, and a location sensor of the vehicle. The display includes an image or a view of an area outside the vehicle, and the control system is responsive to information from the location sensor to provide on the display at least one augmented reality (AR) graphic that is positioned within the image or view of the area outside the vehicle so that the display shows both the image or view and the AR element.

In at least some implementations, the AR element is a game element and the AR element is located relative to the area surrounding the vehicle so that as the vehicle moves, the vehicle moves relative to the AR element.

In at least some implementations, the display is a heads-up display on or near a vehicle windshield and through which at least part of the area outside the vehicle can be viewed.

In at least some implementations, the system also includes an AR source including memory and instructions saved in the memory and relating to providing the at least one AR element, wherein the AR source includes a second communication device that communicates with the communication device of the vehicle and provides the at least one AR element to the vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view showing two vehicles connected to a remote server that provides Augmented Reality (AR) elements to the vehicles;

FIG. 2 is a schematic view of an AR system;

FIG. 3 is a diagrammatic view of a geofence area for a game and showing AR elements of the game;

FIG. 4 shows a heads-up display of a vehicle that has AR elements integrated in the view of the environment outside the vehicle; and

FIG. 5 is a flowchart of a method of providing an AR system for vehicles.

### DETAILED DESCRIPTION

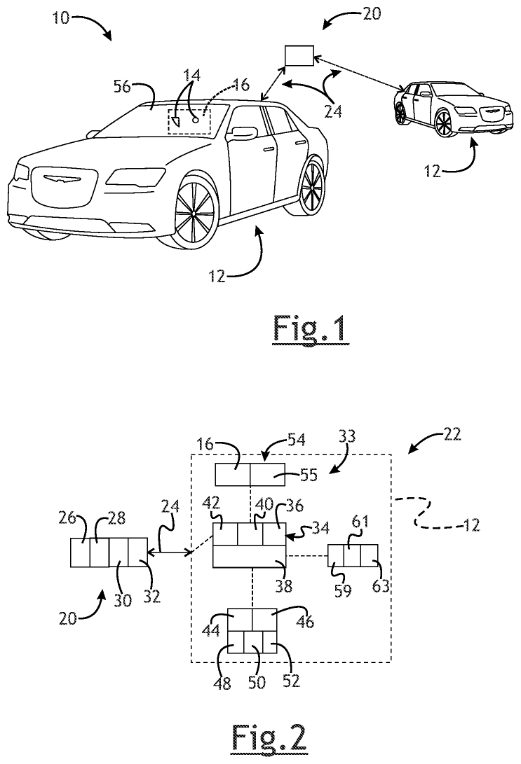

Referring in more detail to the drawings, FIG. 1 illustrates an augmented reality (AR) system 10 for a vehicle 12 that may be of any type and size to transport, for example, a driver and optionally one or more passengers. The AR system 10 may provide AR elements 14 on a display 16 of the vehicle 12 to permit, for example, interactive game play that includes operation of the vehicle 12 in a real-world environment with AR elements 14 integrated and displayed with the real-world environment.

The AR system 10 may utilize two-way communication between one or more vehicles and/or between a vehicle 12 and a remote AR source to enable real-time interactive displays in the vehicle 12 that take into account vehicle location and/or movement. According to one non-limiting example, the remote AR source is a remote server or servers and may be structured as a private cloud and generally includes, as shown in FIG. 2, a backend portion 20 and a frontend portion 22 that is included in one or more vehicles, permitting the AR system 10 to be used by a single vehicle or multiple vehicles together in an interactive manner. Communication between the backend portion 20 and frontend portion 22 may occur over a secure communications network 24 (e.g., secure vehicle-to-cloud (V2C) network). The secure communications network 24 may include a cellular-based network, a satellite-based network, a city-wide WiFi-based network, some other type of communications network and/or a combination thereof.

Backend portion 20 may include any suitable combination of software and/or hardware resources typically found in a backend of a cloud-based system, as best illustrated in FIG. 1, and is generally responsible for receiving and analyzing real-time vehicle-based information from one or more vehicles 12 and/or other data sources that may provide information relevant to the vehicle 12 (e.g., daylight, weather conditions, traffic level, etc.) and for sending AR elements 14 and other information to the vehicle 12. The backend portion 20 is typically responsible for managing some of the programs and algorithms that run applications on the frontend portion 22, such as those that provide the AR elements 14 in a vehicle 12 and may provide text, audio or other communications within the vehicle 12. The backend portion 20 may be managed or controlled by the vehicle manufacturer and can be part of a larger cloud-based system that the vehicle manufacturer uses to communicate and interact with a large fleet of vehicles for a multitude of purposes, not just the AR system 10.

The backend portion 20 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 20). In one example, the backend portion 20 has a number of backend resources including data storage systems 26, servers 28, communication systems 30, programs and algorithms 32, as well as other suitable backend resources. It should be appreciated that backend portion 20 is not limited to any particular architecture, infrastructure or combination of elements, and that any suitable backend arrangement may be employed.

Frontend portion 22 may include any suitable combination of software and/or hardware resources typically found in a frontend of a cloud-based system, as shown in FIG. 2, and is generally responsible for receiving real-time information and AR elements 14 from the backend portion 20, and for conveying such information within the vehicles. Depending on the particular arrangement, the frontend portion 22 may also be responsible for gathering camera, sensor, location and/or other data from devices on the vehicle 12 and sending such information to the backend portion 20, although this depends on the configuration of the overall system 10.

The frontend portion 22 is typically responsible for running the applications used by vehicle occupants, and for interfacing with the programs and algorithms 32 of the backend portion 20. The frontend portion 22 may also be managed or controlled by the vehicle manufacturer and can be part of a larger cloud-based system that the vehicle manufacturer uses to communicate and interact with a large fleet of vehicles for various purposes, as mentioned above.

The frontend portion 22 may be distributed across one or more vehicles and may include any suitable combination of software and/or hardware resources including, but not limited to, components, devices, computers, modules and/or systems (each of these resources is referred to herein as a “frontend resource,” which broadly includes any such resource located at the frontend portion 22). In one example, the frontend portion 22 has a number of frontend resources including a vehicle control system 33 having one or more vehicle electronic module(s) 34 installed in vehicles 12, where each vehicle electronic module 34 may include some combination of a data storage unit 36 (e.g. memory), an electronic control unit 38, applications 40, a communications unit 42 (e.g., one that includes a telematics unit and/or other communication devices), as well as other suitable frontend resources.

Vehicle electronic module 34 may be a telematics control module (TCM), a body control module (BCM), an infotainment control module, or any other suitable module known in the art. It is not necessary for the preceding units to be packaged in a single vehicle electronic module, rather, they could be distributed among multiple vehicle electronic modules, they could be stand-alone units, they could be combined or integrated with other units or devices, or they could be provided according to some other configuration. It should be appreciated that frontend portion 22 is not limited to any particular architecture, infrastructure or combination of elements, and that any suitable frontend arrangement may be employed.

In addition to the frontend portion 22, the vehicle 12 may further include one or more camera(s) 44, proximity sensors 46, a vehicle speed sensor 48, steering angle sensor 50, location sensor 52 (e.g. GPS unit), an infotainment system 54 including audio and visual devices, and other components, as desired. The camera 44 may be of any type and may include infrared, night-vision or other modes or devices suitable to extend the ability of the cameras 44 to function in different conditions and times of day.

The infotainment system 54 may have a display 16 or more than one display 16 by which information is provided to vehicle occupants. A display 16 may be part of an instrument panel or dashboard mounted display by which various information is provided to the driver, such as information relating to a Human-Machine Interface (HMI) 55 that enables use or adjustment of climate controls, radio or other audio systems, interior and exterior lights, control of vehicle cameras 44, mobile devices (e.g. mobile phones), vehicle settings and the like. The display 16 may be part of a so-called Heads-Up Display 16 (HUD), as shown in FIGS. 1 and 4, where the display 16 may be part of or provided on or adjacent to a vehicle windshield 56 (FIG. 1) located at a front of a passenger compartment of the vehicle 12 and through which a driver looks to see the environment 58 (FIG. 4) outside and in front of the vehicle 12. With a HUD 16, a driver can see displayed information as well as the outside environment 58 at the same time or with having to only minimally divert their eyes from their normal view through the windshield 56. Vehicle information 57 such as current speed, direction, speed limits and other information may be provided on the HUD 16. Instead, or in addition to the HUD, the display may include or be defined by a user worn device, such as AR glasses (Hololens, as one non-limiting example) or the like, which may be connected with the vehicle by wired or wireless connection.

The vehicle location sensor 52 may be a GPS component and from this sensor, a location of the vehicle 12 can be determined in real-time and/or at a desired intervals or a desired time. The location sensor 52 and display 16 may be used to indicate a current position of the vehicle 12 on a map, or on an image or graphic provided from, for example, one or more vehicle cameras 44 or from the backend portion 20. In at least some implementations, images from multiple cameras 44 are combined to provide an image of the area surrounding the vehicle 12, up to 360-degrees of viewing around the vehicle 12. This enables a user to see the area surrounding and outside the vehicle 12, and AR elements 14 may be associated with this area. In other implementations, the AR elements 14 are associated with an area viewable through the windshield 56 which facilitates use of the HUD 16 for the purpose of viewing and interacting with the AR elements 14.

The vehicle speed sensor 48 may be the sensor commonly included with vehicles, and by which a speedometer or real-time vehicle speed is provided on an instrument panel or elsewhere so the driver can be aware of the vehicle speed. The vehicle speed sensor 48 could instead use information from the vehicle location sensor 52 with a rate of change of location used to determine vehicle speed.

To facilitate control of the vehicle 12 and display of the information from the various sensors, the frontend portion 22 a part of which may be a vehicle control system 33 is communicated with the sensors by wired or wireless connection. The control system 33 includes at least one controller 12. In order to perform the functions and desired processing set forth herein, as well as the computations therefore, the controller 12 may include, but not be limited to, a processor(s), computer(s), DSP(s), memory, storage, register(s), timing, interrupt(s), communication interface(s), and input/output signal interfaces, and the like, as well as combinations comprising at least one of the foregoing. For example, controller 12 may include input signal processing and filtering to enable accurate sampling and conversion or acquisitions of such signals from communications interfaces and sensors.

As used herein the terms control system 33 or controller 12 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. “Memory,” as used herein can include volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system that controls or allocates resources of a computing device, and can store instructions relating to the various functions and programs and games noted herein and otherwise.

In addition to interfacing with the backend portion 20 and/or the frontend portion 22 or other vehicles, the control system 33 may include driver assistance and safety systems, which may be part of an Advanced Driver Assistance System (ADAS). Such systems may utilize information from the various sensors and devices of the vehicle 12 to assist or control one or more of vehicle steering and speed. Various object detection and object recognition devices may be included. For example, the vehicle 12 may include one or more of radar, lidar, sonar or other sensors 46, and these sensors may be used in different ways by different systems of the vehicle 12. For example, the vehicle 12 may include lane-keeping assistance which uses various vision/proximity sensors 46 to determine a lane or path for the vehicle 12 and may adjust the vehicle steering angle as the vehicle 12 moves along a travel path to keep the vehicle 12 within a desired path. The vehicle 12 may include speed control systems like cruise control which may adjust the vehicle throttle to maintain a set speed or distance from a vehicle ahead or as desired, and an emergency braking system which may actuate the vehicle brakes to reduce vehicle speed up to and including fully stopping the vehicle 12. The vehicle 12 may include blind spot detection to alert a driver to objects not within direct view of the driver, pedestrian detection to alert a driver to pedestrians near the vehicle 12, and traffic sign detection to enable compliance with posted traffic signs (e.g. stop signs, stoplights, one-way traffic signs, etc). Of course, the vehicle 12 may include other drive assistance and safety systems, like anti-lock brakes, traction control and the like.

In at least some implementations, the memory or other content source includes augmented reality (AR) elements 14 that may be used to provide information to the driver, such as for entertainment or gaming purposes. The AR elements 14 may include images, text, video animations or a series of images arranged to be provided in some order to provide dynamic or moving information to the display 16 for viewing by the driver. The AR elements 14 may also include sounds or tactile outputs noticeable by a vehicle occupant, such as vibrations provided to a surface or object interacted with by an occupant (e.g. a seat, steering wheel, game controller or the like), and visual elements not presented on a display, such as activation of interior or exterior lights, which may be done in patterns or locations of the vehicle 12 as desired. Further, lights or elements may be activated to alert others within view of the vehicle 12 that the vehicle 12 is engaged in a game.

The AR elements 14 may be purely fictional as in a game-play element, or the AR elements 14 may facilitate navigation of the vehicle 12 to one of many vehicle travel path options or locations, or to other game icons or features, as desired, and these may be used in a game or otherwise. The AR elements 14 may indicate locations of other vehicles involved with the game, obstacles, a geofence 60 or areas that are within the game and/or not within the game, and the like. The AR elements 14 can be provided on the HUD 16 in a way that they are lined-up with or otherwise associated with features of the area outside the vehicle 12, such as a road ahead or terrain features, with respect to the viewpoint or vision of the driver. This provides an augmented reality (AR) view in which the AR elements 14 are oriented in the driver's field of view of the actual environment outside the vehicle 12 and not just an image of the area on the display 16. In this way, the driver sees a mix of AR elements 14 within a view of environment outside the vehicle 12.

In at least some implementations, to provide a more realistic AR experience with the AR element, information from a vehicle inertial measurement unit (IMU 24) may be used to alter the location of a displayed AR element 28 on the screen 24 as a function of an orientation of the vehicle 12. The IMU 24 may be a combination of an accelerometer and a gyroscope. Linear accelerations, like the vehicle 12 bouncing up and down, etc., are handled by the accelerometer, and angular acceleration/rotation rate, such as when the vehicle 12 pitches due to hard acceleration or braking, speed bumps, etc., are handled by the gyroscope. By way of non-limiting examples, if the vehicle 12 is decelerating the vehicle 12 may pitch forward and downwardly and the content may be provided higher on the display 16 than when the vehicle 12 is traveling at a constant rate. Similarly, acceleration may pitch the vehicle 12 upwardly and content may be positioned lower on the display 16. Still further, jounce or bounce may be detected and the display of information moved to offset the vehicle 12 movement steadier so that the content appears to be more part of the outside environment and not fixed on the display 16. Further, the size of the graphical AR elements 14 displayed may decrease from lower point on the display 16 to a higher point on the display 16 to give the appearance that the smaller and higher icons are farther away along the path of travel 20. The size of an AR element may also change as the vehicle 12 moves toward or away from the location with which the AR element is associated, to improve the perceived reality of the system.

Accordingly, detecting and taking into account vehicle location, and accelerations/pitching/rotation, such as may be determined by the IMU 24, may improve the perception of AR and help the content appear more seamless with the environment outside the vehicle 12. In this regard, such vehicle movements can make alignment between graphical content and the intended “scene”, the environment outside the vehicle 12, is more difficult. This is because with a HUD, the dynamic graphics are projected onto an image plane that is a set distance away from the viewer, and if the content is meant to be overlayed or displayed relative to an object or aspect of the real-world environment outside the vehicle 12, aligning the two so they look correct to the driver is somewhat difficult, and the IMU can help to improve alignment of the display content.

In addition to where and what to display, the time to start the display of an AR element and the duration of the display 16 can be determined by the system, where important to the experience or game being played. Each AR element 28 may have an associated total time of display (e.g. animation runtime), or one or more or all of the files 28 may be displayed for a variable amount of time, as desired. The total time of display is the duration of the file 28 when played from beginning to end. System parameters may provide a minimum and a maximum length of time and the files 28 may have a display time between those limits.

The AR system 10 can merge generated content with views of the real-world, where the views may be obtained directly by the user (e.g. through a window/windshield 56 of the vehicle 12) or obtained from a camera 44 or other imaging device. Further, the AR system 10 can be used while the vehicle 12 is being operated, so that steering, throttle and braking inputs are actions that result in movement of the vehicle 12 in real-life and also in the game environment. In this way, the vehicle 12 may be navigated along a game area including AR elements 14 associated with the game being played, while also navigating real-world terrain over which the vehicle 12 is driven. Various games and game scenarios may be undertaken, including single-vehicle games in which a single vehicle is driven in the game area to complete one or more game objectives, and multiple-vehicle games in which multiple vehicles are driven in the game area in competition or to cooperatively achieve game objectives, or both.

Additionally, the AR system 10 may include games or tasks that can be achieved while the vehicle 12 is stationary, such as after the vehicle 12 has been driven to a location in which the AR system 10 provides a task to be completed without vehicle movement. In this way, different tasks may be provided when the vehicle 12 is in different locations, combining vehicle movement and stationary game play. Such games or tasks could be attempted with a game controller connected to the control system 33, or by various inputs provided in the vehicle 12, such as the steering wheel 59 (FIG. 2), throttle 61, brake pedal 63, buttons on the steering wheel, touch screens or other devices by which a user may use the HMI and make selections or cause things to happen in the game, such as moving a displayed AR element/icon around the display screen 16 or otherwise controlling an AR element (e.g. an icon representing a player in the game).

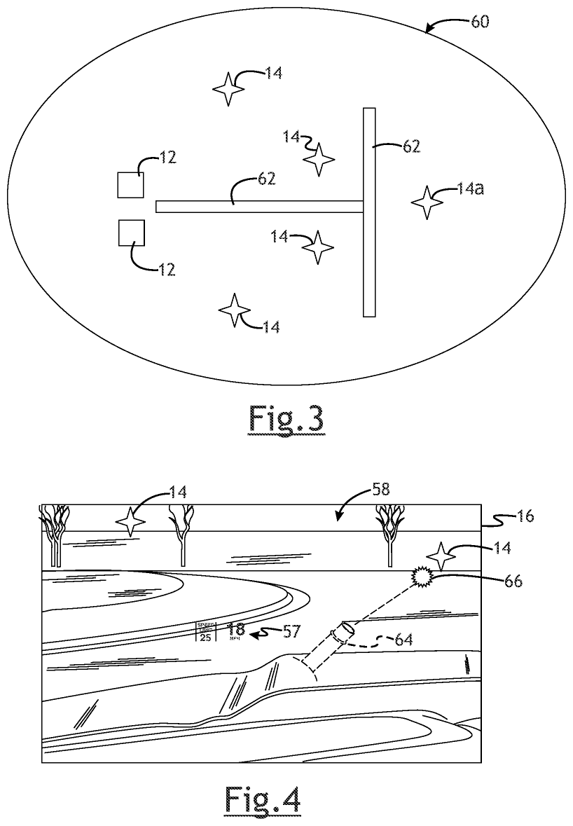

For example, as shown in FIG. 4, a game area is denoted by a geofence 60 or boundary in which the vehicles 12 playing the game must remain. In at least some implementations, the AR system 10 functions in a confined or designated area, such as but not limited to park, off-road park, racetrack or other area. The geofence 60 may include internal barriers 62 or boundaries as well, and vehicles may be prevented from passing through such barriers 62 by the game system, which may, via the vehicle control system 33, prevent a vehicle 12 from being driven through or over an AR element 14 that is a barrier or obstacle (e.g. by braking to slow or stop a vehicle 12 traveling toward such an element). Internal boundaries or barriers 62 are shown in gray in FIG. 3, and two vehicles 12 are represented by the squares. Further, AR elements 14 shown as stars are part of the game objective in this example. In one form, the vehicle 12 must be driven through the area including a star 14 to collect the star, and each vehicle 12 is tasked with collecting the stars 14 on a respective side of the game area 60. The vehicles 12 may race to the final star 14a shown outboard of the internal obstacles 62 and the vehicle/player that collects the final star 14a may be the winner of that game. In a single player mode, the shortest time to collect each star 14 may be the objective, or otherwise, as desired.

In another form, as shown in FIG. 4, the game includes AR elements 14 that may be a virtual weapon 64 (e.g. cannon or gun) via which AR elements 14 such as virtual projectiles 66 (e.g. missiles or bullets) may be virtually “fired” from the weapon 64 at the stars, with the goal being to hit each star 14 with a virtual projectile 66, and the vehicle/player that hits the most stars wins the game. In this example, the vehicle 12 may be stationary when the projectiles 66 are fired at one target, but moved to be in position to hit other targets.

In another game, similar to Wii Tanks, the vehicles 12 may fire virtual projectiles at moving targets and/or at each other, where virtual obstacles may be provided that limit areas in which a direct shot can be made. External barriers may limit the game area over which vehicles may move, may define all or part of the geofence 60, and may also deflect virtual projectiles, permitting bank shots, and the vehicles may be driven to avoid being hit by a projectile.

The targets and projectiles and other vehicles/players may be provided as AR elements 14 on a display 16 in the vehicle 12 for viewing by a driver along with the real-world environment outside their vehicle 12. The above games are just a few examples of games that may be implemented. In these examples, the vehicles 12 may be in a designated area separated from other vehicles to enable safe game play as a driver engaged with a game may have diminished awareness of their surroundings and nearby people or vehicles or objects. To further improve safety, the vehicle control system 33 has primary control of the vehicle's driving functions and can utilize the sensors and other devices and various driver assistance systems, like emergency braking, throttle control, steering control and the like, to ensure the vehicle 12 is safely operated.

Still further, while games similar to non-vehicle video games are noted above, the AR elements 14 may be used in other applications. For example, AR elements 14 may be used to train a driver to properly navigate an off-road area with various obstacles by helping to navigate the driver relative to the obstacles, or along a racetrack or other area. Further, a game similar to escape rooms could be set up with the vehicle 12 driving to different areas of a map to get clues useful in solving problems that enable the vehicle 12 to advance to different portions of the game area and eventually “escape” from the game area to win the game. Other games or tasks, like navigating a virtual/AR maze can be provided with a vehicle 12 driving relative to AR elements 14 that define the maze. Still further, the AR elements 14 may include areas in which the vehicle 12 cannot travel, as well as areas in which the vehicle 12 can only travel in a certain direction or a certain mode (e.g. in reverse) or at a limited speed, or the like. These can be implemented by the control system 33 of the vehicle 12 to provide further interactive elements and additional AR options.

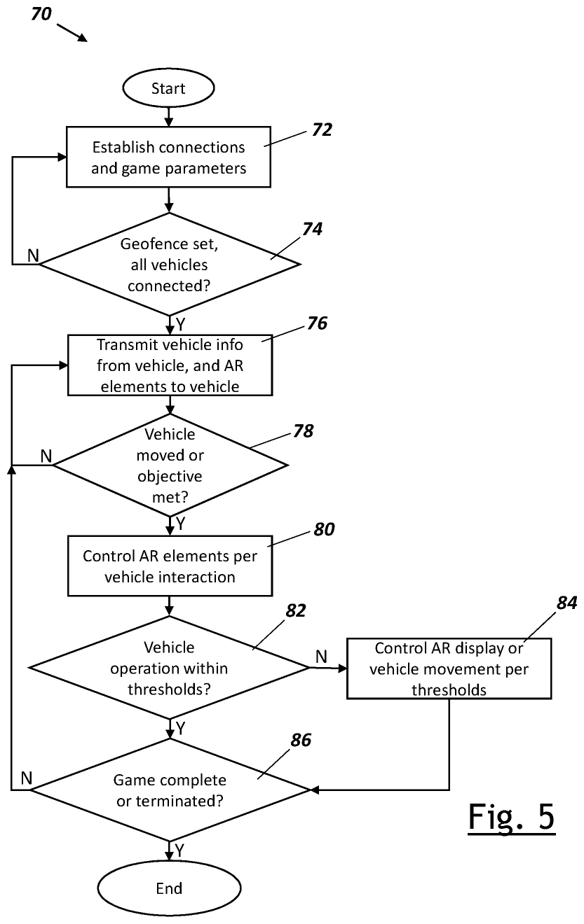

FIG. 5 shows a method 70 that may be used to provide AR elements 14 to a vehicle 12, for a game experience or otherwise. The method may begin at step 72 in which a user establishes a connection between their vehicle 12 and the backend portion, and selects a game to play and perhaps various options relating to the game including whether other vehicles will participate in the game. In step 74, a geofence 60 for that game may be established and a check can be made to ensure that all vehicles participating in the game are within the geofence 60. This can be done by the vehicles transmitting data relating to the location of the vehicles to the remote server for comparison to the geofenced area 60. If a vehicle 12 is not within the geofence 60, then the vehicle 12 can be guided to the geofenced area 60 by AR elements 14 or other instructions transmitted to the vehicle 12.

When the vehicle(s) 12 is/are confirmed to be within the geofence 60, then method may proceed to step 76 in which AR elements 14 are sent from the remote server to the vehicle(s) for display within the vehicles, such as on a HUD 16 on the windshield 56. The AR elements 14 sent to each vehicle 12 may relate to and may be associated with the location of that vehicle 12 such that different vehicles are provided with different AR elements 14. In this way, the AR elements 14 may be associated with the environment outside a particular vehicle 12 and not necessarily the same for each participating vehicle 12. In at least some implementations, the AR element may be displayed in context with the area outside the vehicle 12, such as by being displayed on or near a window through which the area outside the vehicle 12 can be viewed or on a display or screen 16 on which is provided image data from a camera 44 of the vehicle 12 that has a field of view including the area. The position of the AR element relative to the area outside of the vehicle 12 may remain as the vehicle 12 moves, which will make the vehicle 12 seem to be moving relative to the AR element, where, for example, the size of the AR element is adjusted as a function of the distance of the vehicle 12 from the AR element. In this way, the display or position of the AR element may be responsive to one or more of movement of the steering wheel or vehicle speed (e.g. actuation of the vehicle throttle or vehicle brake). The AR element displayed may relate to another vehicle and may be moved on the display 16 as a function of movement of that vehicle. The AR elements 14 may be stationary with respect to a location in the environment, or they may move, as desired.

Further, as the vehicle 12 moves, different AR elements 14 may be transmitted to the vehicle 12. For example, the vehicle 12 may move beyond an area for a first AR element display and into an area in which a second AR element is displayed. Also or instead, time or achievement or failure to achieve certain objectives in the game may cause a different display of one or more AR elements 14. In this way, the method may include in step 78 transmitting to the remote device some vehicle data relating to motion of the vehicle 12 or game interactions, and transmitting in step 80 an AR element to the vehicle 12 that corresponds to the new location of the vehicle 12, or to a new or different phase/portion of the game or AR setting provided to the vehicle 12. AR elements 14 may be displayed as a function of GPS data from the vehicle 12, or data from one or more vehicle cameras 44 or proximity/obstacle detection sensors 46, as desired. Vehicle data relating to actuation of inputs may also be transmitted. Such inputs may be actuated to accomplish tasks within a game or AR setting, similar to actuation of inputs on a handheld gaming controller. This may move AR elements 14 on the screen or cause actions relative to one or more AR elements 14 on the screen (e.g. fire a virtual missile at an AR target as one example).

For safety or other reasons, display of one and up to all AR elements 14 may be terminated, at least temporarily, if one or more vehicle parameters are outside of a corresponding threshold for that vehicle parameter. For example, the one or more vehicle parameters may include vehicle speed and the corresponding threshold is a maximum vehicle speed, or the one of the one or more vehicle parameters may include a proximity of the vehicle 12 to an obstacle and the corresponding threshold is a minimum distance of the vehicle 12 to the object (e.g. closest in path vehicle (CIPV) or time to collision (TTC), or the one of the one or more vehicle parameters may be a geofence 60 and the corresponding threshold is a location of the vehicle 12 relative to the geofence 60. In this way, in step 82, the method may compare one or more vehicle parameters to a threshold and in step 84 terminate the display of at least one AR element when a vehicle parameter is outside or beyond a corresponding threshold.

In addition or instead of stopping the AR display, in step 84 the operation of the vehicle 12 may be adjusted by the control system 33 to bring the vehicle parameter within the corresponding threshold. For example, the vehicle steering, throttle or brakes may be actuated to bring the vehicle parameter within the threshold, or to prevent the vehicle 12 from operating with a parameter outside of the corresponding threshold before that occurs. Such decisions may be made in accordance with predetermined thresholds, and with the use of the ADAS systems and sensors of the vehicle 12. The thresholds may be based on safety and to avoid the vehicle 12 colliding with an object, or part of the game play (e.g. limited speed or no-go zones, etc).

Thereafter, the method 70 may check in step 86 to determine if the game is complete or if a request to terminate the game has been received, and if so, the method may end. If not, the method may return to monitor and control game play and the vehicle operation by looping back to step 76.

The AR system 10 may thus be provided in a vehicle 12 and may be responsive to use of the vehicle 12 which can provide an immersive experience for a user who feels the forces dur to motion of the vehicle 12 and sees the surrounding, real-world environment in which the vehicle 12 is moving. Such forces and movement may be used to adjust the AR elements 14 provided to the user both based on location and time, and also based on rate of speed and other vehicle data. While a remote server (e.g. backend portion of a cloud system) is described, a vehicle control system 33 may include the game program and implement the game program locally. Further, vehicles 12 may communicate with the remote device/backed portion or with each other, or both, and one or more vehicles may be a “host vehicle” that includes the gaming program(s) and acts as the AR source and controls the game play for one or more other vehicles and may transmit information to the other vehicles to control AR elements 14 displayed or provided in the other vehicles. Such an AR source has a control system with memory, and a communication device to receive and transmit information and accomplish the functions noted herein. Still further, the AR source/game interface or control may be provided by a remote device within a vehicle 12, such as a smartphone, tablet or computer that is connected to the vehicle control system 33. Such an in-vehicle remote device also has a controller and memory to execute programs, and a communication device enabling communication with other vehicles, other similar devices and/or with the remote server/backend portion.

What is claimed is:

1. A method, comprising:
transmitting, from a vehicle to an Augmented Reality (AR) source, vehicle data relating to a location of the vehicle;
receiving, at the vehicle from the AR source, an AR element selected based on the vehicle data;
displaying the AR element on a display of the vehicle, wherein the AR element is displayed in context with an area outside the vehicle, and the AR element is displayed on or near a window through which the area can be viewed or on a display on which is provided image data from a camera of the vehicle that has a field of view including the area.

2. The method of claim 1, wherein the display is a heads-up display that includes at least a portion of a windshield of the vehicle.

3. The method of claim 1, wherein the AR element includes one or more icons that are provided on the display so that they appear in a predetermined context relative to the area outside the vehicle.

4. The method of claim 1, wherein the display of the AR element is responsive to one or more of movement of a steering wheel, movement of a throttle or movement of a brake pedal.

5. The method of claim 1 wherein the AR element is displayed as a function of the current location of the vehicle, with a different AR element displayed when the vehicle is at a different location.

6. The method of claim 1, wherein the AR element is associated with a particular location outside the vehicle and the size of the AR element increases as the vehicle moves closer to the particular location.

7. The method of claim 1, which also includes determining one or more vehicle parameters, comparing each of the one or more vehicle parameters to a corresponding threshold, and terminating the display of the AR element when one of the vehicle parameters is outside of the corresponding threshold for that vehicle parameter.

8. The method of claim 7 wherein one of the one or more vehicle parameters includes a vehicle speed and the corresponding threshold is a maximum vehicle speed, or the one of the one or more vehicle parameters includes a proximity of the vehicle to an obstacle and the corresponding threshold is a minimum distance of the vehicle to the object, or the one of the one or more vehicle parameters is a geofence and the corresponding threshold is a location of the vehicle relative to the geofence.

9. The method of claim 1 which also includes comparing the location of the vehicle to a geofence and terminating the display of the AR element when the vehicle is outside of the geofence.

10. The method of claim 1 wherein the vehicle data includes information from a GPS device.

11. The method of claim 10 wherein the vehicle data includes information from the camera, and the AR element is displayed as a function of image data from the camera.

12. The method of claim 1 wherein the AR element relates to a different vehicle that is connected to the server.

13. The method of claim 4 which also includes moving the AR element in response to actuation of an input within the vehicle.

14. The method of claim 1 which also includes controlling at least one of steering, throttle or braking of the vehicle as a function of information from a safety system of the vehicle.

15. The method of claim 14 wherein the safety system includes sensors used by an Advanced Driver Assist System, and the sensors include one or more of a camera 44, Lidar, Radar, location sensor.

16. The method of claim 1 which also includes providing sound in the vehicle as a function of the AR element or the vehicle location.

17. A system, comprising:
a display within a vehicle;
a communication device of the vehicle permitting wireless communication to and from the vehicle;
a vehicle control system coupled to the display and to the communication device, the vehicle control system including a controller and memory including instructions executable by the processor; and
a location sensor of the vehicle, wherein the display includes an image or a view of an area outside the vehicle, and the control system is responsive to information from the location sensor to provide on the display at least one augmented reality (AR) graphic that is positioned within the image or view of the area outside the vehicle so that the display shows both the image or view and the AR element.

18. The system of claim 17 wherein the AR element is a game element and the AR element is located relative to the area surrounding the vehicle so that as the vehicle moves, the vehicle moves relative to the AR element.

19. The system of claim 17 wherein the display is a heads-up display on or near a vehicle windshield and through which at least part of the area outside the vehicle can be viewed.

20. The system of claim 17 which also includes an AR source including memory and instructions saved in the memory and relating to providing the at least one AR element, wherein the AR source includes a second communication device that communicates with the communication device of the vehicle and provides the at least one AR element to the vehicle.
